(19) United States
(12) Patent Application Publication
(10) Pub. No.: US 2019/0308292 A1
(43) Pub. Date: Oct. 10, 2019

(54) METHOD AND APPARATUS FOR FINISHING AN INTERNAL CHANNEL OF A COMPONENT

(71) Applicant: ROLLS-ROYCE plc, London (GB)

(72) Inventors: Arun Prasanth NAGALINGAM, Singapore (SG); Kai Liang TAN, Singapore (SG); Moiz Sabbir VOHRA, Singapore (SG); Wei Lun TAN, Singapore (SG); Swee Hock YEO, Singapore (SG); Arthur WEE, Singapore (SG)

(73) Assignee: ROLLS-ROYCE plc, London (GB)

(21) Appl. No.: 16/293,705

(22) Filed: Mar. 6, 2019

(30) Foreign Application Priority Data
Apr. 6, 2018 (GB) 1805763.8

(51) Int. Cl. B24B 31/116; B08B 9/032; E03C 1/306

(52) U.S. Cl. CPC B24B 31/116; B08B 9/0322; B08B 2209/032; B08B 2209/005; E03C 1/306

(57) ABSTRACT

There is disclosed a method and apparatus for finishing an internal channel of a component. The method comprises installing the component in a flow circuit which is configured to drive a fluid flow through the internal channel and controlling the fluid flow through the internal channel so that cavitation bubbles are continuously generated by a hydrodynamic effect to erode the internal channel by implosion of the cavitation bubbles. The fluid flow may comprise abrasive media which may abrade the internal channel.

### CROSS REFERENCE TO RELATED APPLICATIONS

This application is based upon and claims the benefit of priority from UK Patent Application No. GB 1805763.8, filed on 6 Apr. 2018, the entire contents of which are which is herein incorporated by reference.

### BACKGROUND

### Technical Field

The disclosure relates to a method of finishing an internal channel of a component, in particular a component made by additive layer manufacture, and an apparatus for finishing an internal channel of a component.

### Description of the Related Art

Additive layer manufacturing (ALM) has been proposed for the manufacture of components having complex geometries, including complex internal structures or channels. However, ALM can produce a component with a rough surface requiring finishing.

Internal channels can be finished by abrasive flow machining (AFM), but this method is slow, and can result in accumulation of abrasive particles at bends and narrow passages, or contamination of the component with abrasive particles.

### SUMMARY

According to a first aspect, there is provided a method of finishing an internal channel of a component, the method comprising: installing the component in a flow line configured to drive a fluid flow through the internal channel; controlling fluid flow through the internal channel so that cavitation bubbles are continuously generated by a hydrodynamic effect to erode the internal channel by implosion of the cavitation bubbles.

A flow restrictor may be provided upstream of the internal channel such that cavitation bubbles are generated by the flow of fluid through the flow restrictor. The flow restrictor may be an orifice plate.

The component may be manufactured by additive layer manufacturing. There may be surface irregularities such as balling melts in the internal channel. The fluid flow may be controlled so that cavitation bubbles are generated by the flow of fluid past balling melts in the internal channel. Cavitation caused by flow over surface irregularities may be referred to as heterogeneous cavitation. In contrast, cavitation caused by a flow restrictor such as an orifice plate may be referred to as homogeneous cavitation.

The pressure of the fluid may be controlled to control an intensity of cavitation bubble generation and/or cavitation implosion. The method may comprise varying the pressure of the fluid through the component to vary the intensity of cavitation bubble generation and/or implosion. The pressure of the fluid through the component may be controlled by controlling a valve upstream of the internal channel and/or a valve downstream of the internal channel.

The fluid may be provided with abrasive media to abrade the internal channel. The abrasive media may be present in the fluid in a concentration of up to 30% (by weight). The abrasive media may comprise particles having a mean particle size of between 10 μm and 100 μm.

The fluid flow may be controlled to generate cavitation bubbles in a first erosion stage so that the internal channel has a first roughness, and abrasive media may be provided in a second abrasion stage to abrade the internal channel to a second lower roughness. In other words, the cavitation bubbles may be generated to leave a coarse finish, and the abrasive media may be provided for fine finishing.

Cavitation bubbles may be continuously generated to erode the internal channel in an erosion stage, and the abrasive media may be added to the fluid in an abrasive stage which commences after commencement of the erosion stage. Accordingly, in some examples such abrasive media is added only after the fluid has been driven through the internal channel in the erosion stage.

The fluid may be provided with the abrasive media such that erosion by implosion of cavitation bubbles and abrasion by abrasive media occur simultaneously. In other words, the erosion stage and the abrasion stage may occur simultaneously. The presence of the abrasive media in the fluid flow may increase the intensity of the cavitation bubble generation.

The method may further comprise locally heating the component at an enhanced smoothing region to locally increase the temperature of the fluid, such that the intensity of cavitation bubble implosion is locally increased. The component may be locally heated using a heating coil.

According to a second aspect, there is provided an apparatus for finishing internal channels of a component, the apparatus comprising: a flow line configured to receive a component; a pump configured to cause fluid to flow through the flow line and the component; and a controller configured to control the fluid flow to generate cavitation bubbles in the component in accordance with the first aspect.

The apparatus may further comprise a connector configured to fluidically connect the flow line with the internal channel of the component.

The apparatus may comprise a sensor to monitor cavitation. The controller may be configured to maintain continuous cavitation conditions based on data received from the sensor.

The apparatus may further comprise an upstream valve configured to be positioned upstream of the internal channel, and a downstream valve configured to be positioned downstream of the internal channel. The controller may be configured to control the upstream valve and/or the downstream valve to control the pressure of the fluid through the component.

The fluid may comprise abrasive particles in a concentration of up to 30% (by weight). The abrasive particles may have a mean particle size of between 10 μm and 100 μm.

According to a third aspect, there is provided an apparatus for finishing internal channels of a component, the apparatus comprising: a chamber configured to receive a component; a pump configured to cause fluid to flow through the chamber and into an internal channel of the component; and a controller configured to control the fluid flow to generate cavitation bubbles in accordance with the first aspect; and heating elements configured to locally heat the component to locally increase the intensity of the cavitation bubble generation.

### DESCRIPTION OF THE DRAWINGS

The disclosure may comprise any combination of the features and/or limitations referred to herein, except combinations of such features as are mutually exclusive.

Embodiments will now be described, by way of example, with reference to the accompanying Figures, in which:

FIG. 1 schematically shows a sectional side view of a gas turbine engine;

FIG. 2 schematically shows an apparatus for finishing internal channels of a manufactured component;

FIG. 3 schematically shows a first example arrangement for receiving the component in the apparatus of FIG. 2;

FIG. 4 schematically shows a second example arrangement for receiving the component in the apparatus of FIG. 2; and

FIG. 5 is a flowchart of an example method of finishing internal channels.

### DETAILED DESCRIPTION

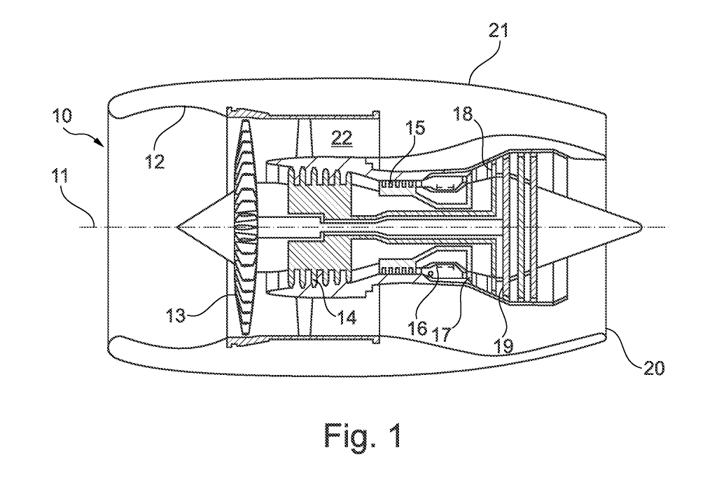

With reference to FIG. 1, a gas turbine engine is generally indicated at 10, having a principal and rotational axis 11. The engine 10 comprises, in axial flow series, an air intake 12, a propulsive fan 13, an intermediate pressure compressor 14, a high-pressure compressor 15, combustion equipment 16, a high-pressure turbine 17, an intermediate pressure turbine 18, a low-pressure turbine 19 and an exhaust nozzle 20. A nacelle 21 generally surrounds the engine 10 and defines both the intake 12 and the exhaust nozzle 20.

The gas turbine engine 10 works in the conventional manner so that air entering the intake 12 is accelerated by the fan 13 to produce two air flows: a first air flow into the intermediate pressure compressor 14 and a second air flow which passes through a bypass duct 22 to provide propulsive thrust. The intermediate pressure compressor 14 compresses the air flow directed into it before delivering that air to the high pressure compressor 15 where further compression takes place.

The compressed air exhausted from the high-pressure compressor 15 is directed into the combustion equipment 16 where it is mixed with fuel and the mixture combusted. The resultant hot combustion products then expand through, and thereby drive the high, intermediate and low-pressure turbines 17, 18, 19 before being exhausted through the nozzle 20 to provide additional propulsive thrust. The high 17, intermediate 18 and low 19 pressure turbines drive respectively the high pressure compressor 15, intermediate pressure compressor 14 and fan 13, each by suitable interconnecting shaft.

Other gas turbine engines to which the present disclosure may be applied may have alternative configurations. By way of example such engines may have an alternative number of interconnecting shafts (e.g. two) and/or an alternative number of compressors and/or turbines. Further the engine may comprise a gearbox provided in the drive train from a turbine to a compressor and/or fan.

Some components in a gas turbine engine may include complex internal channels with bends and narrow passages, such as pipes for conveying fuel from one location to another. Such components may be manufactured by a number of manufacturing techniques, and some of those techniques may result in rough surfaces that may be surface finished to improve performance and/or geometric compliance. For example, such components may be manufactured by additive layering manufacturing (ALM). It may be advantageous to smooth an internal surface of a component. For example, in the case of a pipe, the internal surfaces may advantageously be smoothed to ensure that fuel can be efficiently and reliably conveyed to the required location.

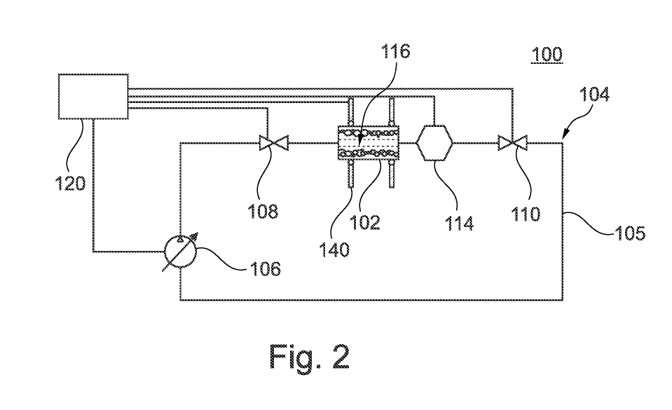

FIG. 2 shows an apparatus 100 for finishing an internal channel 116 of a manufactured component 102. The apparatus comprises a continuous flow circuit 104, having a continuous flow line 105 which is configured to direct fluid through the channel 116 of the component 102, receive fluid from the channel 116 and return it in a continuous loop. In other examples, fluid may be directed to flow through a non-continuous flow line.

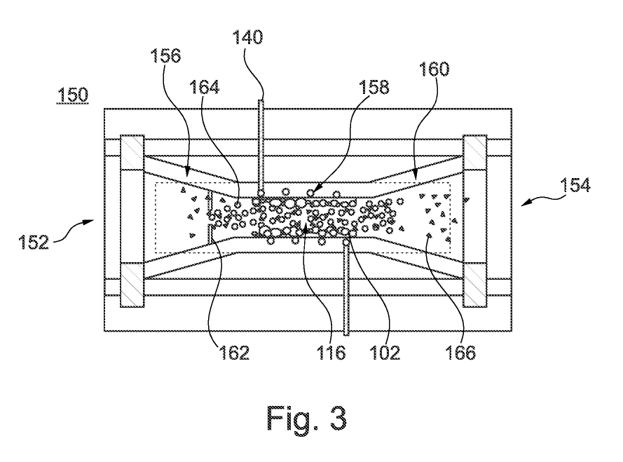

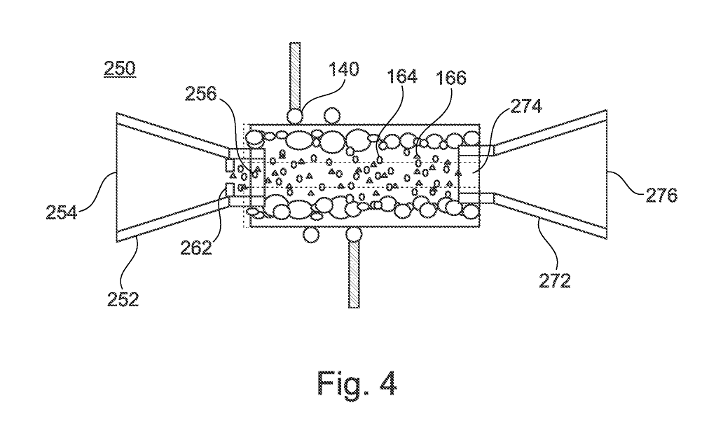

The component 102 is received in the flow line 105 such that the internal channel 116 is fluidically connected to the flow line 105 to receive fluid from an upstream portion of the flow line 105 and discharge fluid back into a downstream portion of the flow line 105. In this example, the component 102 is manufactured by ALM, and therefore may comprise surface irregularities such as balling melts, stepping effects on the surface of the internal channel 116. However, in other examples, the component may be made by any suitable manufacturing method. The component FIGS. 3 and 4 described below show examples arrangements for connecting the flow line 105 to the component 102 in more detail.

The apparatus 100 is configured to finish an internal channel of the component 102 by directing and controlling a fluid flow through the internal channel such that cavitation bubbles are formed by a hydrodynamic effect, in particular due to a drop in hydrostatic pressure below the vapour pressure of the working fluid at a given temperature. Without wishing to be bound by theory, the cavitation bubbles are thought to implode to generate shock waves which in turn generate micro jets. The micro jets are thought to cause micro pits or cracks on the surface of the internal channel 116, and thereby remove loosely bonded particles on the internal surface, or erode or remove balling melts from the internal surface of a component made by ALM.

The flow circuit 104 comprises a pump 106 which is configured to drive the fluid around the flow circuit 104. In this example the pump 106 pumps fluid in a clockwise direction around the flow line 105 loop as shown in FIG. 2 and is a variable flow pump so that the flow rate of the fluid in the flow circuit 104 can be varied. However, in other examples, the pump may be a fixed flow pump and/or may be operated to pump in two directions.

The flow circuit 104 further comprises an upstream valve 108 and a downstream valve 110. The upstream valve 108 is located upstream of the component 102 relative to the flow direction in use, and the downstream valve 110 is located downstream of the component 102 relative to the flow direction in use. The upstream valve 108 and the downstream valve 110 can be used to control the pressure of the fluid in the internal channel 116 of the component 102 as will be described below.

In this example, the upstream valve 108 is located between the pump 106 and the component 102, and the downstream valve 110 is located between the component 102 and the pump 106. However, in other examples, the pump may be located anywhere in the flow circuit 104 to drive fluid through the component 102 when in use.

The flow circuit 104 also comprises a sensor 114 which is located between the upstream valve 108 and the downstream valve 110 and is configured to monitor acoustic conditions of the fluid flow through the component 102 to monitor cavitation intensity i.e. a parameter relating to the intensity of the eroding and/or abrading effect of cavitation bubbles in the flow. The sensor 114 may be, for example, an acoustic emissions (AE) sensor, an acoustic sensor (such as hydrophone or a polyvinylidene fluoride (PVDF) sensor).

In this example, the apparatus 100 comprises a heater 140 configured to locally heat the component 102 at a heating location on the component, and thereby locally heat fluid at an internal location corresponding to the heating location. In this particular example, the heater 140 comprises two heating coils 140 disposed around an outer surface of the component 102 at upstream and downstream heating locations spaced apart along a length of the component corresponding to the direction of flow through the internal channel 116. Increasing the temperature of the fluid is thought to increase the cavitation intensity by increasing the generation of cavitation bubbles by a hydrodynamic effect, and increasing the intensity of the cavitation implosion.

In other examples, the apparatus may comprise a heater configured to heat fluid upstream of the component, for example a heater disposed within the fluid upstream of the component or at an internal location within the component, so that the fluid is heated directly by the heater.

The apparatus 100 further comprises a controller 120 which is connected to the pump 106, the upstream valve 108, the downstream valve 110, the sensor 114 and the heating coil 140. The controller 120 is configured to receive data from the sensor 114. In this example, the controller 120 is configured to control any or all of the pump 106, the upstream valve 108, the downstream valve 108 and the heating coil 140 to maintain the cavitation intensity at a predetermined level based on data received from the sensor 114. In other examples, the controller may be configured to display the sensor data to a user to permit manual control and variation of the pump and/or valves by user input.

FIG. 3 shows a first example arrangement 150 for receiving the component 102 within the flow circuit 104. In this example arrangement, the component 102 is received in the flow circuit 104 of FIG. 2 within a chamber 150. The chamber 150 comprises an inlet 152 and an outlet 154 separated along a longitudinal direction and which are fluidically connected to the flow lines 105 of the flow circuit to complete the flow loop of the flow circuit 104 as described above.

In this simplified example, the component 102 is a simple tube or pipe, extending along an axial extent with a constant diameter. In other examples, the component 102 may be any shape and may have any number of complex internal channels for finishing.

The chamber 150 has a circular cross section in planes normal to the longitudinal direction and defines a convergent-divergent passage for fluid flow. The passage comprises a convergent upstream portion 156, a central portion 158 and a divergent downstream portion 160.

In this example the central portion 158 is substantially cylindrical with internal dimensions corresponding to external dimensions of the component 102, and the component 102 is received therein.

The component may be retained in the central portion by any suitable means, such as by clamping, by a frictional fit, or by virtue of cooperating formations of the central portion 158 and the component 102. Although the central portion 158 in this example is cylindrical, it may be of any shape to accommodate a component which for internal finishing.

In this example, the heating coil 140 of the apparatus has a longitudinal extent corresponding to the longitudinal extent of the component 102 so as to provide substantially uniform heating along the component. In other examples, there may be no heater, or there may be more than one heater configured to locally heat distinct portions of the component (as will be described below with reference to FIG. 4).

The upstream portion 156 of the passage further comprises a flow restrictor 162, which is configured to have an opening narrower than the local diameter of the upstream portion and configured to generate cavitation bubbles 164 by a hydrodynamic effect in fluid flowing therethrough. In this example, the flow restrictor 162 is in the form of an orifice plate.

In use, the component 102 is received in the chamber 150 and the pump 106 pumps fluid around the flow circuit 104. The pump 106, upstream valve 108, downstream valve 110 and heating coil 140 may be controlled by the controller 120 to maintain a predetermined cavitation intensity, or according to predetermined operating parameters (e.g. pump speed, valve setting, heating power).

The fluid in this example is pure water for an erosion stage of finishing in which the surface of the internal channel is finished to a coarse finish (e.g. relatively high roughness), and further comprises suspended abrasive media 166 for an abrasive stage of finishing in which the surface is finished to a finer finish (e.g. relatively lower roughness). The abrasive media may comprise abrasive particles that are present in fluid in a concentration of up to 30% (by weight). The concentration range of up to 30% (by wt.) of abrasive particles provides for a particularly effective finer finish to the surface of the component. The abrasive particles may have a mean particle size of between 10 μm and 100 μm. The abrasive particles may be formed from any suitable abrasive material such as, for example, silicon carbide, cubic boron nitride, alumina, hematite, quartz, and apatite.

In other examples, the fluid may be any fluid with a viscosity of between 0.1 mPa·s and 100 mPa·s at 25 degrees Celsius.

The fluid passes through the orifice plate 162 so that cavitation bubbles 164 form in the fluid. The cavitation bubbles 164 flow with fluid along the internal channel of the component 102, until they implode in proximity to the surface, thereby removing loosely bonded particles on the internal surface, or remove balling melts from the internal surface.

Implosion of cavitation bubbles in such a fluid flow is thought to accelerate the abrasive media 166 in the abrasive stage, thereby increasing the effectiveness of the abrasive media 166 and the speed of surface finishing. Further, the inclusion of abrasive media 166 may cause additional cavitation bubbles to be generated in a fluid flow (i.e. when compared to a similar flow without abrasive media). Therefore, the intensity of cavitation bubble generation may be increased by the presence of abrasive media 166 in the flow.

FIG. 4 shows a second example arrangement 250 for receiving the component 102 within the flow circuit 104 of FIG. 2. In this example arrangement, the component 102 is received between an upstream nozzle 252 and a downstream nozzle 272. Both nozzles 252, 272 are configured for fluidically connecting to the flow line 105 of FIG. 2.

The upstream nozzle 252 is configured to connect at its inlet end 254 to the flow line 105 and is connected at its outlet end 256 to the component 102. The upstream nozzle 252 has a circular cross section of variable diameter and tapers from the inlet end 254 to the outlet end 256. The upstream nozzle 252 has a portion of constant diameter at the outlet end 256.

The downstream nozzle 272 is configured to connect at its outlet end 276 to the flow line 105 and is connected at its inlet end 274 to the component 102. The downstream nozzle 272 has a circular cross section of variable diameter and tapers from the outlet end 276 to the inlet end 274. The downstream nozzle 272 has a portion of constant diameter at the inlet end 274.

The outlet end 256 of the upstream nozzle 252 and the inlet end 274 of the downstream nozzle 272 are sized to fit into the respective ends of the component 102 to fluidically connect the internal channel of the component 102 to the flow line 105.

The upstream nozzle 252 comprises a flow restrictor 262 which is similar to the flow restrictor 162 described with reference to FIG. 3. In use, the flow restrictor 162 causes cavitation bubbles 164 to be formed by a hydrodynamic effect when fluid is driven through it.

In this example, the heating coil 140 is wound around the component 102 at an enhanced treatment region i.e. at a region on the component 102 where it is intended to promote additional local smoothing. It may be desirable to target the cavitation bubbles to erode the internal surface with a higher intensity at the enhanced smoothing region, for example to provide a locally-smoother surface (e.g. for performance), or erode a locally-rougher surface (e.g. where a manufacturing method may generate a region of relatively high local roughness). In use, the heating coil 140 locally increases the temperature of the component 102 and thereby fluid in the internal channel 116, so as to locally increasing the cavitation intensity.

Accordingly, the second example arrangement for receiving a component in the flow circuit according to FIG. 4 differs from the first example arrangement described above with respect to FIG. 3 in that a heater is provided to locally heat a sub-portion of the component, rather than being distributed along the full extent of the component. Such heating arrangements are interchangeable, such that the full-length heater of FIG. 3 could be applied to the arrangement of FIG. 4, and vice versa.

Although it has been described that the first and second example arrangements 150, 250 each comprise a flow restrictor 162, 262 upstream of the component 102, in some examples, there may be no flow restrictor, and cavitation bubbles may be formed by interaction of the flow with the balling melts in the internal channel and/or the abrasive media in the abrasive stage.

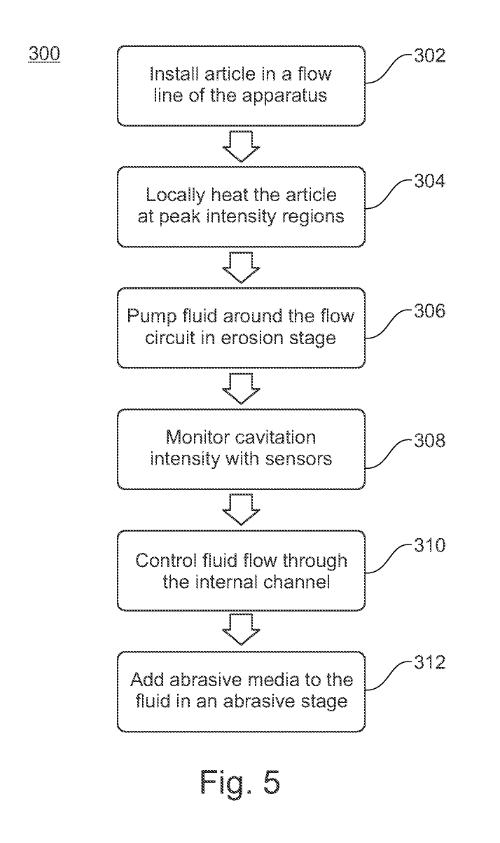

FIG. 5 is a flowchart 300 showing a method of finishing an internal channel 116 of a component 102. By way of example, the method is described with reference to the apparatus 100 of FIGS. 2 to 4.

In block 302 of the method 300, the component 102 is installed in the flow line 105 of the apparatus 100. The component 102 can be received in the apparatus in any manner which allows fluid to flow through the internal channel of the component 102, such as the arrangements 150, 250 described with reference to FIGS. 3 and 4.

In block 304, the heating coil 140 is heated to heat the component uniformly or at one or more enhanced smoothing regions. This increases the temperature of the fluid, either evenly or locally, thereby increasing the cavitation intensity when the fluid flows.

In other examples, there may be no heating coil in the apparatus, and/or block 304 of the method may not be carried out.

In block 306, the pump 106 pumps fluid around the flow circuit 104, and into the internal channel 116 of the component 102 in an erosion stage. In this example, the fluid passes through the flow restrictor 162, 262 which causes generation of cavitation bubbles by a hydrodynamic effect. In this example, the component 102 has been manufactured by ALM, and therefore the surface of the internal channel 116 may comprise balling melts. The balling melts also act as small constrictions in the flow, such that flow over the balling melts generates cavitation bubbles.

The cavitation bubbles implode in proximity to walls of the internal channel 116. As explained above, implosion of the cavitation bubbles generates shock waves which may generate micro jets. It is thought that the micro jets cause micro pits or cracks on the surface of the internal channel 116, so as to remove loosely bonded particles on the internal surface, or erode/remove the balling melts.

In block 308, the cavitation intensity is monitored with the sensors 114. The cavitation intensity relates to the amount of cavitation bubbles which are generated and/or to the intensity of implosion of the cavitation bubbles.

In this example, the cavitation intensity is monitored with the sensors 114 at a high sampling rate (e.g. 8 kHz to 180 kHz), and the sensors 114 send the data to the controller 120. In this example, the sensors 114 include an acoustic sensor configured to generate an acoustic parameter (e.g. amplitude in a predetermined or peak frequency band, peak frequency, energy in a predetermined or peak frequency band) which is a function of the cavitation intensity. In yet other examples, the cavitation intensity may not be monitored at all, but may be estimated using a formula.

In block 310, the controller 120 receives data from the sensors 114 and controls the fluid flow through the internal channel 116 by controlling any or all of the pump 106, upstream valve 108, the downstream valve 110 and the heating coil 140. By controlling the fluid flow in response to the data received from the sensors 114, the controller 120 can control the cavitation intensity in the internal channel 116. In other examples, the sensor 114 may transmit data to a display for a user. In further examples, the controller may respond directly to inputs from the user to control the pump, the valves and the heating coil, or may apply pre-determined settings for each of the respective components

Each one of blocks 304 to 310 may be performed concurrently or sequentially with each other. For example, fluid may be continuously pumped around the flow circuit. Heating, monitoring and control may be conducted whilst the fluid is being pumped around the flow circuit in the erosion stage.

The cavitation bubbles erode the surface of the internal channel by removing balling melts and loosely bonded particles. Erosion by the cavitation bubbles is thought to leave a relative coarse surface finish (e.g. relatively high surface roughness).

In this example, further fine surface finishing is done using abrasive particles. In block 312, abrasive media 166 is added to the fluid flow in an abrasive stage. In the abrasive stage, the pump 106 continues to pump fluid around the flow circuit 104 according to block 306, the sensors 114 continue to monitor the cavitation intensity according to block 308, and the controller 120 continues to control the cavitation intensity based on data from the sensor 114. In some examples, local heating may also continue in the abrasive stage (block 304)

The abrasive media 166 abrades the internal channel 116, in the abrasive stage, to a finer finish than that achieved by the cavitation bubbles alone in the erosion stage. In this example, cavitation bubbles continue to be generated in the abrasive stage, and it is thought that implosion of the cavitation bubbles accelerates the abrasive media to enhance the abrasive effect

It is thought that the abrasive media 166 may have surface imperfections which trap gases while travelling at high speeds, resulting in a local pressure drop, and thereby generating more cavitation bubbles to accelerate the abrasive media and enhance the finishing.

It is thought that whilst cavitation bubbles may be effective in removing relatively large imperfections in the surface of the internal channel 116, such as loosely bonded particles and balling melts, they may be less effective (at least without abrasive media) in smoothing or removing the bulk material of the component. The abrasive media 166 is therefore introduced to abrade the surface, and may smooth it to a finer finish (e.g. a relatively lower roughness) than the cavitation bubbles alone.

Since the abrasive media 166 is suspended in a low viscosity fluid, the risk of abrasive particle accumulation at narrow portions or complex bends is reduced when compared to methods relying on a higher viscosity fluid.

In examples where the abrasive stage follows the erosion stage, the cavitation bubbles remove blockages in the internal channels before the abrasive media is introduced, to further reduce the risk of abrasive particle accumulation at narrow portions. By using a two-stage finishing procedure (e.g. erosion then abrasion) the speed of the finishing process to achieve a target roughness may be reduced, by providing a relatively fast coarse surface finish in the erosion stage to remove excess material, before applying the finer finishing with the abrasive particles to achieve the target roughness.

Although in this example, it is described that the abrasive stage follows the erosion stage, in other examples, the erosion stage and abrasive stage may occur simultaneously, e.g. the abrasive media may always be provided in the fluid flow. This may also speed up the finishing process as it is thought that the cavitation bubbles and abrasive media erode and abrade the surface simultaneously, until the cavitation bubbles no longer effectively erode the internal channel. At this point it is thought that the further finishing results primarily from the abrasive media fine alone, without any significant further erosion from the coarser cavitation bubbles, as the cavitation bubbles may not remove the well bonded material from the surface.

What is claimed is:

1. A method of finishing an internal channel of a component, the method comprising:
installing the component in a flow circuit configured to drive a fluid flow through the internal channel;
controlling fluid flow through the internal channel so that cavitation bubbles are continuously generated by a hydrodynamic effect to erode the internal channel by implosion of the cavitation bubbles.

2. The method according to claim 1, wherein a flow restrictor is provided upstream of the internal channel such that cavitation bubbles are generated by the flow of fluid through the flow restrictor.

3. The method according to claim 2, wherein the flow restrictor is an orifice plate.

4. The method according to claim 1, wherein the component is manufactured by additive layer manufacturing and there are surface irregularities in the internal channel, wherein the fluid flow is controlled so that cavitation bubbles are generated by the flow of fluid past the surface irregularities in the internal channel.

5. The method according to claim 1, wherein the pressure of the fluid is controlled to control an intensity of cavitation bubble generation and/or cavitation implosion.

6. The method according to claim 5, wherein the method comprises varying the pressure of the fluid through the component to vary the intensity of cavitation bubble generation and/or implosion.

7. The method according to claim 5, wherein the pressure of the fluid through the component is controlled by controlling a valve upstream of the internal channel and/or a valve downstream of the internal channel.

8. The method according to claim 1, wherein the fluid is provided with abrasive media to abrade the internal channel.

9. The method according to claim 8, wherein the fluid is provided with abrasive media in a concentration of up to 30% (by weight).

10. The method according to claim 9, wherein the abrasive media comprises particles having a mean particle size of between 10 μm and 100 μm.

11. The method according to claim 8, wherein cavitation bubbles are continuously generated to erode the internal channel in an erosion stage, and
wherein the abrasive media is added to the fluid in an abrasive stage which commences after commencement of the erosion stage.

12. The method according to claim 8, wherein the fluid is provided with the abrasive media such that erosion by implosion of cavitation bubbles and abrasion by abrasive media occur simultaneously.

13. The method according to claim 1, further comprising locally heating the component at an enhanced smoothing region to locally increase the temperature of the fluid, such that the intensity of cavitation bubble implosion is locally increased.

14. The method according to claim 1, wherein the component is locally heated using a heating coil.

15. An apparatus for finishing internal channels of a component, the apparatus comprising:
a flow line configured to receive a component;
a pump configured to cause fluid to flow through the flow line and the component; and
a controller configured to control the fluid flow to generate cavitation bubbles in the component in accordance with claim 1.

16. The apparatus according to claim 15, further comprising a connector configured to fluidically connect the flow line with the internal channel of the component.

17. The apparatus according to claim 15, comprising a sensor to monitor cavitation.

18. The apparatus according to claim 17, wherein the controller is configured to maintain continuous cavitation conditions based on data received from the sensor.

19. The apparatus according to claim 15, further comprising an upstream valve configured to be positioned upstream of the internal channel, and a downstream valve configured to be positioned downstream of the internal channel, wherein the controller is configured to control the upstream valve and/or the downstream valve to control the pressure of the fluid through the component.

20. The apparatus according to claim 15, wherein the fluid comprises abrasive particles in a concentration of up to 30% (by weight).

21. The apparatus according to claim 20, wherein the abrasive particles have a mean particle size of between 10 μm and 100 μm.

22. An apparatus for finishing internal channels of a component, the apparatus comprising:
a chamber configured to receive a component;
a pump configured to cause fluid to flow through the chamber and into an internal channel of the component; and
a controller configured to control the fluid flow to generate cavitation bubbles in accordance with claim 1; and
heating elements configured to locally heat the component to locally increase the intensity of the cavitation bubble generation.
